(19) United States
(12) Patent Application Publication
(10) Pub. No.: US 2008/0079571 A1
(43) Pub. Date: Apr. 3, 2008

(54) Safety Device

(76) Inventor: Ramin Samadani, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/537,087

(22) Filed: Sep. 29, 2006

(51) Int. Cl. G08B 13/18; G08B 23/00

(52) U.S. Cl. 340/552; 340/573.1

(57) ABSTRACT

Methods and systems for detecting a warning condition and alerting a headphone wearer to the warning condition. One exemplary device includes a headphone configured to be worn by the user and a sensor in electronic communication with the headphone. The sensor is configured to monitor external signals in an external environment. The device further includes a processor in electronic communication with the sensor. The processor is configured to process the external signals monitored by the sensor; identify external signals indicative of an approaching object; and produce an alert responsive to identification of an approaching object.

### BACKGROUND

In today's world of mobile devices, e.g. MP3 players, cell phones, PDAs and the like, people often move around in environments without paying attention to potentially dangerous conditions. For example, joggers listening to music through headphones may be unable to hear an approaching car. Similarly, people listening to loud music in cars may be unable to hear approaching emergency vehicles or other cars. This can lead to hazardous, even fatal, accidents.

A number of safety devices have been described that detect a signal that is emitted from a potentially hazardous object (such as a construction truck) and alert a device user when the user comes within a certain proximity of the object. However, the headphones are not able to alert the headphone wearer comes into proximity with objects that do not emit the signal. Moreover, these devices sound the alarm whether or not the hazardous object is approaching the device user.

Other safety devices have been described that detect when a certain sounds, such as a siren. However, these safety devices do not determine whether or not the source of the sound is approaching the device user.

Accordingly, there is a need for a safety device configured to warn the device user when an object is approaching the user.

### BRIEF DESCRIPTION OF THE DRAWINGS

FIG. 1 is a block diagram of a device 10 according to one embodiment of the present invention.

FIG. 2 is a graph depicting idealized energy signatures of three automobiles as they approach and then pass a pedestrian with varying nearest distances and different power.

FIG. 3 is a graph depicting the short term audio power produced by an automobile as it approaches and then passes a pedestrian.

FIG. 4 is a flowchart of an exemplary method according to an embodiment of the present invention.

### DETAILED DESCRIPTION

The present disclosure provides various devices and methods. According to one embodiment, the disclosure provides a device incorporating a system configured to alert a user upon detection of a predetermined signal indicative of a warning condition. According to a further embodiment, the warning condition may be an approaching object. Accordingly, in one embodiment, the disclosure provides a safety device incorporating a system configured to alert a user when an object is approaching the user.

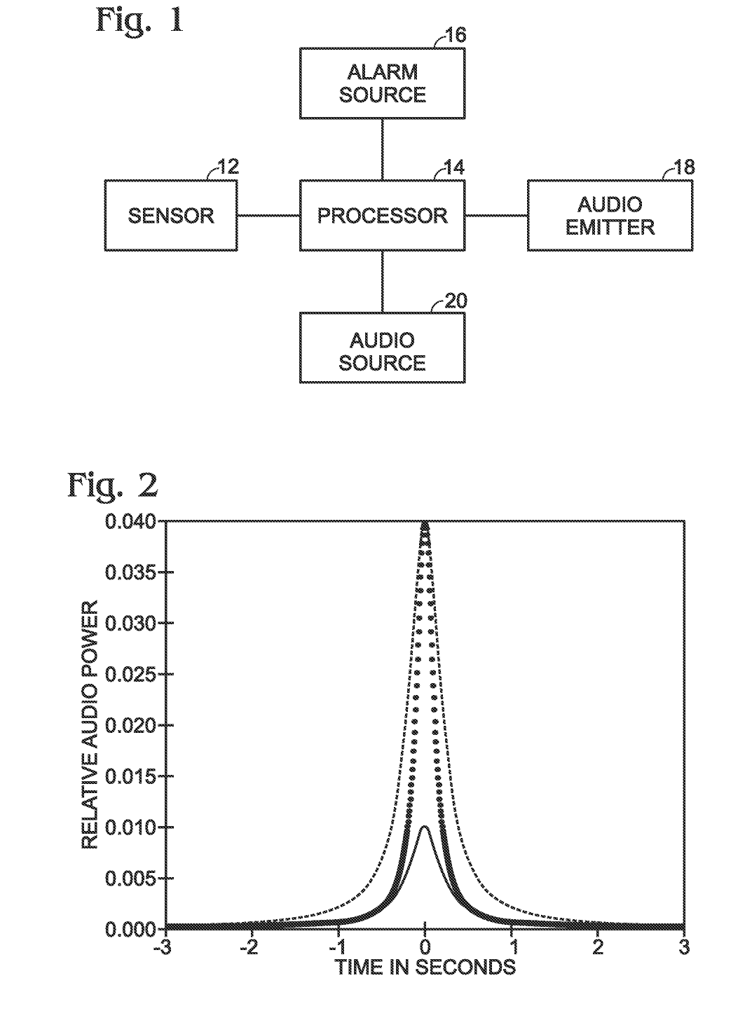

FIG. 1 is a block diagram of a system 10 according to one embodiment of the present invention. It should be understood that system 10 may be a stand-alone device or may be incorporated into any suitable type of device. For example, system 10 may be incorporated into a headset or earphones that can be worn by a user. Alternatively, system 10 may be incorporated into a personal listening device such as an MP3 player, CD player, cassette player, radio, cell phone, personal data assistant (PDA), handheld computer, notebook, laptop, tablet PC, or any other handheld or portable device. As a further alternative system 10 may be incorporated into a larger device or object such as a bicycle, motorcycle, car, construction equipment, etc.

System 10 includes a sensor 12. Sensor 12 is configured to monitor the external environment surrounding the device user. According to one embodiment, sensor 12 may be or include one or more microphones configured to monitor external audio signals produced by the external environment. For the purposes of the present disclosure, the term “external audio signal(s)” refers to audio signals that can be heard in the environment surrounding the device user (though not necessarily by the user) and that are not produced by system 10 or any components thereof. Alternatively, sensor 12 may take the form of a video camera, sonar device, radar device, or any other device suitable for monitoring the proximity and velocity of various objects.

In the depicted embodiment, sensor 12 is in electronic communication with a processor 14. It should be understood that the term “processor” is intended in its broadest possible sense, as any electronic or mechanical device, system, or sub-system, capable of performing the described function(s). Accordingly, a processor may or may not include any type of memory device and/or any type of hardware, software, firmware, etc. Furthermore, for the purposes of the present disclosure, the phrase “in electronic communication with” shall be interpreted to include all forms of electronic communication, whether wired, or wireless. Moreover, the term “in electronic communication with” does not imply that the various identified component parts are or are not part of the same device or mechanism.

Processor 14 is configured to receive and process signals from sensor 12 in order to filter out background and other uninteresting signals and enhance signals of interest. It will be understood that the specific signals that will be identified as signals of interest by the processor will differ depending on the specific desired function of the system 10. For example, a system that is incorporated into an MP3 player that is intended to be worn by a jogger could enhance signals created by cars and other vehicles as signals of interest. Alternatively, or additionally, signals that match human speech may or may not be considered signals of interest. Various exemplary methods for enhancing signals of interest are discussed below. System 10 may incorporate any suitable method for enhancing signals of interest, including, but not necessarily limited to, those methods described herein.

Upon detection of a signal of interest, processor 14 may be configured to further process the signal to determine if the signal of interest fits within a given set of parameters in order to determine if a warning condition exists. For example, in the case where system 10 is configured to identify and alert the user to objects that are approaching the user, it will be understood a given signal may be created by the type of object the system was designed to identify but that the signal does not indicate that the object is approaching the user.

As a more specific example, system 10 may be configured to enhance all signals whose signatures indicate they are created by an automobile. However, not all signals created by automobiles will need to raise an alert. For example, signals caused by traffic passing the user at a given “safe” distance or cars that are heading away from the user would not create a warning condition. Accordingly, the parameters of signal signatures that are indicative of an approaching automobile may be identified and the system configured only to alert the user when the signal of interest fits within those parameters. It will be appreciated that the specific identified parameters will be dependent upon the type of signal being monitored (i.e. audio or visual), the monitoring method, (e.g. microphone, radar, sonar, video camera) and various other factors.

Once the processor has determined that a warning condition exists, processor 14 is configured to provide an alert to the user. The form of the alert may vary, as desired. For example, the alert may include an audible alarm, a visual alarm, a tangible alarm, or a combination of any of these.

Accordingly, system 10 may further include an alarm source 16. Alarm source 16 may be configured to produce or enable the production of the alarm, depending upon the type of alarm mechanism employed by the system. Examples of suitable audible alarm mechanisms include, but are not limited to, the muting or lowering of any internal audio signal (such as that produced by audio source 20, described below), or a sound such as a beep, buzz, ringing noise, voice command, or the like. Examples of suitable visual alarm mechanisms include, but are not limited to, turning on, flashing, or otherwise altering a light, alteration of a visual display such as a device menu or heads up car display, etc. Examples of suitable tangible alarm mechanisms include, but are not limited to, vibration, alteration of physical characteristics such as shape or color, or the like. Accordingly, alarm source 16 may be configured to produce or direct the production of the audible, visual, or tangible alarm.

Processor 14 may further include or be in electronic communication with a mixer (not shown). The mixer may be any device configured to receive multiple audio signals, such as those generated by alarm source 16 and audio source 20 and mix and/or alter the audio signals when a warning condition is detected.

Processor 14 may be in electronic communication with an audio emitter 18. Audio emitter 18 is typically a device or mechanism configured to deliver one or more audio signals to the user. According to some embodiments, audio emitter 18 may take the form of a headphone, headset, earphone, earbud, speaker, or other similar device. For the purposes of the present disclosure, the term “headphone” is used to refer to an audio emitter configured to be worn by the user of system 10. Typically, a headphone delivers the audio signal directly to the user's ear. Accordingly, “headphone” refers not only to headphones, but also to earphones, headsets, earbuds, and the like.

Processor 14 may also be in electronic communication with an audio source 20. The audio source is any device, mechanism, etc. configured to produce an audio signal that the user can listen to via the audio emitter. For example, the audio source may be an MP3 player, CD player, radio, cell phone, PDA, personal computer, handheld computer, car stereo, or the like.

Accordingly, in response to detection of a given external audio signal, such as a quickly approaching automobile, an exemplary system 10 may be configured to lower the volume of the audio signal produced by the audio source, emit a warning sound, cause the device to vibrate, and cause LED lights on the device to flash. According to some embodiments, the user may be able to decide which types of alerts he or she would like to receive and in response to what external audio signal(s).

It should be understood that according to some embodiments, a system as described in the present disclosure may be incorporated into a device that is intended to be a stand-alone safety system configured to provide warning to a user upon detection of a warning condition. In such a case, there may be no need for an audio emitter 18 or audio source 20, depending on the type of alert that is generated and how such alert is to be delivered to the user. For example, the present disclosure also contemplates a device, which may or may not be worn on the user's body, which detects a given signal and alerts the user by vibrating or flashing lights. Of course such a device could also incorporate headphones, in which case an alert could alternatively or additionally be delivered to the user via the headphones.

As stated above, according to some embodiments processor 14 is configured to determine if any of the external audio signals monitored by sensor 12 is a signal of interest. According to one embodiment, an audio signal is a signal of interest if it is indicative of an object that is approaching the user.

According to one embodiment, processor 14 may be configured to examine the power signature of the audio signals monitored by sensor 12. If an object is producing a constant energy signature (i.e. volume), the energy signature of the sound produced by the object typically increases as the object approaches the sensor. Accordingly, processor 14 may be configured to identify those audio signals that demonstrate an increase in energy.

FIG. 2 is a graph depicting idealized energy signatures of three automobiles as they approach and then pass a pedestrian with varying nearest distances and different power (i.e. loudness). The parameters of the curves can be used to predict the nearest distance and speed of the automobile.

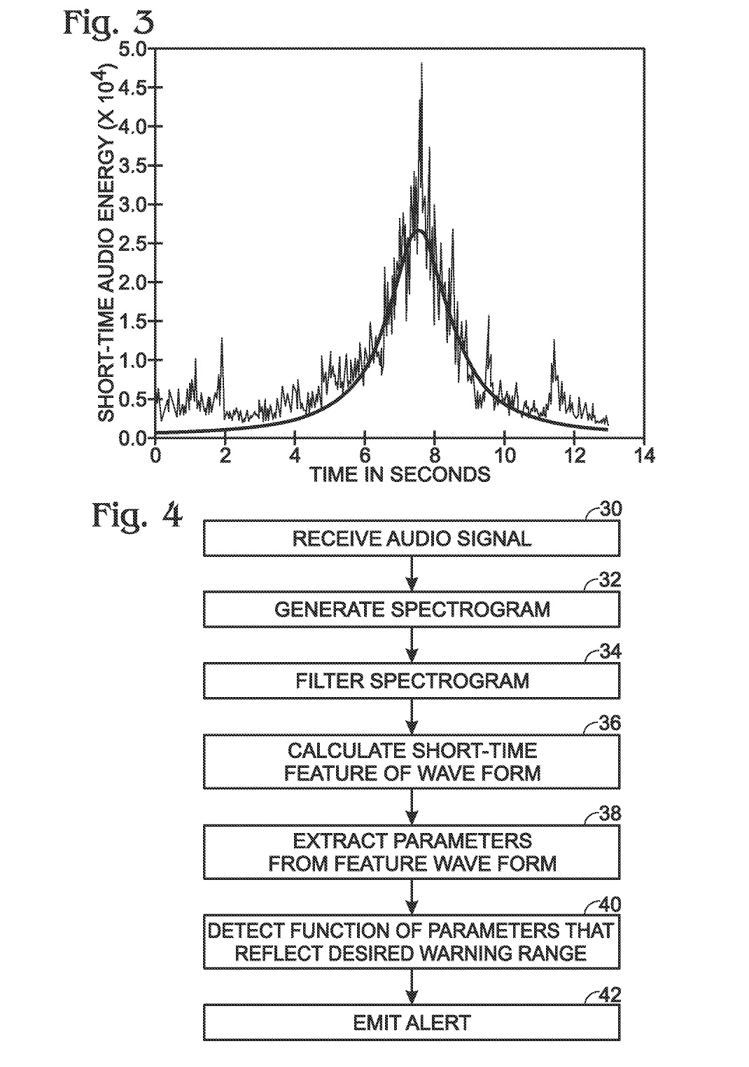

FIG. 3 is a graph depicting the short term audio power produced by an automobile as it approaches and then passes a pedestrian. As shown, the “best fit” for the graph of FIG. 3 can be calculated to produce a curve that fits the actual audio power. As stated above, the parameters of the curve fit can be used to determine the car's estimated speed, power, and directionality (i.e. whether the car is moving towards or away from the user). Accordingly, processor 14 may be configured to measure the energy signature over time of each external audio signal and determine whether any of the monitored external energy signatures fit within the parameters of a signal of interest. The processor may be configured to identify any external energy signature having parameters within a certain range as an audio signal of interest. The desired range may be determined based on the types of moving objects the device is intended to alert the user to. For example, it may be determined that it would only be desirable to alert users to cars that are approaching at more than 25 miles per hour. Accordingly, the typical energy signatures could be determined and a threshold defined. If an energy signature is determined to have a value that is higher than the defined threshold, the signal could be identified as a signal of interest.

Another method could use stereo microphone information to triangulate the position of the object producing an audio signal. The object's position could then be tracked over time. An audio signal that belongs to an object that is demonstrating a clear approach path towards the user could then be identified as a signal of interest.

Still another method could use the spectral characteristics of an audio signal to filter out various unimportant signals that make up part of the external audio environment. For example, signals produced by human speech, music, turboprop airplane engines, or that have too fast or too slow a rate of change to be an object of interest could be ignored. Alternatively or additionally, a spectrogram of the audio signal could be filtered for certain signals of interest. For example, signals that show the spectral characteristics of car engines could be identified as signals of interest.

Further, processor 14 could be configured to analyze the aspects of audio power that do not change through time (stationarity) and aspects of audio power that do change through time (non-stationarity) of the spectrogram. A possible method for detecting the stationary portions of the spectrogram are found in the paper “Reducing audio noise using spectrogram random textures” by Ramin Samadani, IEEE Asilomar Conference on Signals, Systems and Computers, October, 2005, which is hereby incorporated by reference in its entirety for all purposes. One way to detect the stationarity is to assume Gaussian Fourier coefficients, leading to Raileigh distributed random variables. Control chart parameters may then be used to detect stationarity within one of the spectral bands of the spectrogram, for example.

The rate of change of power of only the non-stationary components of the spectrogram could be used during computations to identify signals of interest.

As stated above, once a signal of interest is identified, processor 14 could apply one or more filters or other processes to determine if the identified signal of interest indicates a warning condition. The stationarity and non-stationarity of the audio power could also be used to determine if a signal indicates a warning condition or is a false alarm. For example, the system may be configured to identify all audio signals whose power levels (i.e. loudness) are over a certain threshold as signals of interest. In such a case, the power signature of an airplane passing overhead may be above the threshold level (because it is very loud). However, because the airplane is relatively far away from the user, the signal will change very little over time. The system can be configured to ignore such signals as not indicative of a warning condition.

Those of skill in the art will be familiar with various other methods to filter out various types of noise and sounds from a given audio signal. Accordingly, background noises and other uninteresting noises could be filtered out using any known means, either before or after signals are identified as being “of interest.”

FIG. 4 is a flowchart of a method that uses the spectral characteristics of the various audio signals in the external environment to filter for signals of interest. At 30, an audio signal is received. At 32, a spectrogram of the audio signal is generated. At 34, the spectrogram is filtered for signals of interest. At 36, a short-time feature, such as energy, is calculated as a function of time, creating a waveform. At 38, parameters are extracted from the waveform. These parameters may correspond to slope, variance or shape of the waveform. At 40, a function of the extracted parameters, (e.g. shape, slope, variance, etc.,) that reflects the desired warning range is evaluated to establish whether an alarm condition exists. At 42, an alert is emitted.

According to various embodiments, the systems and methods described herein could be adapted to monitor for various types of warning conditions other than, or in addition to, approaching objects. For example, the systems and methods of the present disclosure could be configured to detect the specific spectral characteristics of human speech. A device could then be configured to detect when someone is speaking to the user and lower the volume of the device or take some other action.

Furthermore, the systems and methods described herein could be applied to various types of internal environments including car or other vehicle interiors. For example, the systems and methods described herein could be used to alert car occupants to approaching emergency vehicles. A sensor, such as one or more microphones, could be placed on the exterior of the car in electronic communication with a processor. The processor could be configured to identify the characteristics of commonly used emergency vehicle sirens and determine when a signal matches an emergency vehicle siren that is approaching the car from behind. If such a signal is detected, the processor could be configured to lower the volume of the car stereo and/or alert the occupants using other audible, visible, or tangible mechanisms.

While the invention has been described with reference to the exemplary embodiments thereof, those skilled in the art will be able to make various modifications to the described embodiments without departing form the true spirit and scope of the disclosure. Accordingly, the terms and descriptions used herein are set forth by way of illustration only and are not meant as limitations.

What is claimed is:

1. A method comprising:
providing a headphone configured to be worn by a user and further configured to deliver an internal audio signal to the user;
monitoring an external environment surrounding the headphone user;
detecting an external signal in the external environment that is indicative of an approaching object;
providing an alert if an external signal indicative of an approaching object is detected.

2. The method of claim 1 further comprising determining the speed of the approaching object.

3. The method of claim 1 wherein the external signal is an audio signal.

4. The method of claim 3 further comprising identifying an audio intensity change in the external audio signal.

6. The method of claim 1 further comprising providing an internal audio signal to the user via the headphone;

7. The method of claim 6 wherein providing an alert comprises lowering the volume of the internal audio signal.

8. The method of claim 6 wherein providing an alert comprises emitting an audible alarm.

9. The method of claim 6 further comprising:
detecting an external audio signal that fits a predetermined set of characteristics; and
altering the internal audio signal upon detection of the external audio signal.

10. The method of claim 9 wherein the predetermined set of characteristics include an external audio signal indicative of speech.

11. The method of claim 9 wherein altering the internal audio signal comprises lowering the volume of the internal audio signal.

12. A device for alerting a user to an external warning condition, the device comprising:
a headphone configured to be worn by the user;
a sensor in electronic communication with the headphone and configured to monitor external signals in an external environment;
a processor in electronic communication with the sensor, the processor being configured to:
process the external signals monitored by the sensor;
identify external signals indicative of an approaching object; and
produce an alert responsive to identification of an approaching object.

13. The device of claim 1 where the external signal is an audio signal.

14. The device of claim 1 further comprising an internal audio source.

15. The device of claim 1 where the internal audio source is configured to be worn by the user.

16. The device of claim 1 wherein the sensor comprises one or more microphones.

17. A computer-readable medium containing one or more programs that perform the steps of:
receiving a signal from a sensor that is part of a device that is configured to be worn by a user;
analyzing the signal to detect a signal indicative of an approaching object; and
indicating that an alert should be delivered if the signal is indicative of an approaching object.

18. The computer-readable medium of claim 17 wherein analyzing the signal further comprises determining the speed of the approaching object.

19. The computer-readable medium of claim 17 wherein the signal is an audio signal.

20. The computer-readable medium of claim 17 wherein the device is further configured to deliver an internal audio signal to the user and wherein the medium further contains one or more programs that perform the step of altering the internal audio signal upon detection of a signal indicative of an approaching object.
